(19) United States
(12) Patent Application Publication
(10) Pub. No.: US 2012/0096402 A1
(43) Pub. Date: Apr. 19, 2012

(54) Method, an Apparatus, and a Computer Program Product for Reducing the Need of User Prompts

(75) Inventors: Andreas Heiner, Espoo (FI); Nadarajah Asokan, Espoo (FI)

(73) Assignee: NOKIA CORPORATION, Espoo (FI)

(21) Appl. No.: 13/378,269

(22) PCT Filed: Jun. 25, 2009
(86) PCT No.: PCT/FI2009/050571

§ 371 Date: Dec. 14, 2011

(51) Int. Cl. G06F 9/46; G06F 3/048

(52) U.S. Cl. 715/810; 718/102

(57) ABSTRACT

The application concerns an apparatus, a computer program product and a method comprising electronically controlling an application to be executed with default policies throughout application tasks; noticing when a default policy is an inappropriate action for an application task being encountered in said application; activating another policy from a list of default and alternative policies to said application. The solution reduces the need of user prompts when a situation expecting a policy decision is encountered.

### BACKGROUND

Many applications have to make policy decisions during their execution. Usually they resort to prompting the user in order to make the decision. The policy decision may relate to access points, software updates, application settings (language, button selection, etc.), user data (location, identification, whether and how positioning system data can be utilized), etc.) and to many various selections.

Nearly all computerized systems (PC application, web sites, mobile devices) use a modal interaction model for selecting alternative modes for program execution (user prompting). Modal interaction means that the operations that the user may perform and order in which those operations are performed are restricted. In some cases, the system has already made a suggestion (suggested a “best” choice), but the user still has to confirm this selection (“The language is changed to “English”. Are you sure?” YES/NO). In one example, the user is forced to read an informational message with only a little informational value (e.g. details such as version number when installing an application) and the user has no other choice but to continue. When the user nearly always selects the best or only choice, the user will become conditioned to make that selection. This will come out when an alternative choice is more appropriate but the user still selects the “best choice”. An example can be found in installing a PC software: accepting end user license agreements and selecting “best” installation mode, etc. Even if the user selects the default mode, the user is prompted with a confirmation for the selection. This procedure has been illustrated in FIG. 1.

### SOME EXAMPLE EMBODIMENTS

The present solution is targeted to an above-mentioned problem so that applications are allowed automatically to make the “best” policy decision and to show alternative choices on demand. This reduces the need of user prompts when a situation expecting a policy decision is encountered.

The solution can be carried out by a method, an apparatus and a computer program product.

An example of the method comprises electronically controlling an application to be executed with default policies throughout the application tasks; noticing when a default policy is an inappropriate action for the application task being encountered in said application; activating another policy from a list of default and alternative policies to said application.

An example of the apparatus comprises a processor and a memory storing executable instructions that, in response to execution by the processor, cause the apparatus to electronically control an application to be executed with default policies throughout application tasks; notice when a default policy is an inappropriate action for the application task being encountered in said application; and to activate another policy from a list of default and alternative policies to said application.

An example of the apparatus comprises processing means configured to execute executable instructions being stored in memory means; controlling means configured to control an application electronically to be executed with default policies throughout application tasks; detection means configured to notice when a default policy is an inappropriate action for the application task being encountered in said application; and activating means configured to activate another policy from a list of default and alternative policies to said application.

An example of the computer program product comprising executable instructions that, in response to execution by a processor, are adapted to perform controlling an application to be executed with default policies throughout application tasks; noticing when a default policy is an inappropriate action for the application task being encountered in said application; activating another policy from a list of default and alternative policies to said application.

According to an example, in order to notice that the default policy results in inappropriate action, a user-initiated request is received to display other policies, wherein as a response to the request, a list comprising default and alternative policies for the encountered situation is displayed on the user interface, the method further comprising receiving a user selection for one of the policies in the list, activating said one of the policies and initiating the application to operate with the activated policy.

According to another example, the step of noticing that a default policy is an inappropriate action comprises automatically selecting one of the policies among default and alternative policies that is suitable for the encountered situation, activating the selected policy and controlling the application to operate with the activated policy.

According to yet another example, the encountered situation relates to an erroneous application setting or to a need to change application setting policies.

According to yet another example, the default policy has been selected by the user or is inferred from user's behaviour.

According to yet another example, the list of default and alternative policies is received via registration request from said application, the registration request further comprising indicating at least one of the following: an identity of the application, a menu of choices to be displayed on the user interface and relating to the policies, a time period during which the menu of choices is active, help information to the user to make the right choice, a callback function, a notification show to the user on the default policy.

According to yet another example the user-initiated request is received via a notification or by an explicit invocation on the user interface.

According to yet another example, the apparatus is a mobile phone further comprising user interface circuitry and user interface software configured to facilitate user control of at least some functions of the mobile phone through use of a display and configured to respond to user input; and a display and display circuitry configured to display at least a portion of a user interface of the mobile phone, the display and display circuitry configured to facilitate user control of at least some functions of the mobile phone.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### DESCRIPTION OF THE DRAWINGS

The present solution is described in the following in more detailed by means of example embodiments and with reference to drawings, where

FIG. 1 illustrates an example of the present solution and the operation of the ombudsman,

FIG. 2 illustrates mobile device screen shots displaying alternative choices due to invoking the ombudsman, and

FIG. 3 illustrates an example of an electronic apparatus.

### DESCRIPTION OF EXAMPLE EMBODIMENTS

The present solution relates to an application independent service for an electronic apparatus, which reduces the need of user prompts and pop-ups when application setting policies are changed or erroneous application settings are corrected. The solution can operate so that a user discovers an incompatible mode (i.e. incorrect behaviour) of an application and requests the service; or that the service discovers an incompatible mode of an application and either corrects it by itself or provides the user a possibility to correct it. It is also possible that the service is only operable via user requests and is not able to detect the incorrect behaviour of an application.

In the present solution registered applications (registration process is described later in the disclosure) are controlled to make the “best” policy decision by themselves throughout their execution. The “best” policy decision depends on the context and the user preferences. In situations where some other choice is more appropriate than the one the application is using, the service of the present solution can show alternative choices on demand. This kind of procedure is user friendly, because the user is not distracted with unnecessary prompts, but still has the means to make changes.

The electronic apparatus utilizing the present solution can be a mobile device (a mobile phone, a PDA (Personal Digital Assistant), a personal computer (PC), a lap-top computer or similar. It is realized that in mobile devices there are more situations which call for policy decisions than e.g. in PCs. For example, in PCs it is possible to have different physical slots for audio in/out, video in/out etc. and the user is expected to use the right connector. On mobile devices, the same physical slot is however used for a variety of connections. Therefore, whenever a connector is inserted into such a slot, the device has to determine the type of the connector.

In addition, the mobile devices have displays of a limited size and therefore not too much room to prompt the user and to get user responses. The disruptiveness and inconvenience of user prompts is therefore more severe. If the response for the prompts is invariably the same, replying to prompts leads to habituation that can have severe consequences in case of security-related matter. Furthermore, showing informational pop-ups that do not present any new information, or information that is implied, are distracting. They also take a substantial display space.

The present solution introduces a service that has a concept of an “ombudsman” to whom the user can turn in a case an application has behaved inappropriately. This solution is suitable in any electronic apparatus, including mobile devices, because prompting is minimized and no extra (and often unhelpful) elements are presented in the display. The ombudsman is configured to guide the user to the relevant settings such that application behaviour and user expectation become aligned. The linkage between application settings and application behaviour is also more apparent.

In the present solution the applications of the apparatus (that have been registered to the ombudsman) are electronically controlled to use a “best” choice (i.e. default policy) without prompting. However, the user may still select an alternative action by activating the ombudsman service, e.g. by pressing a certain ombudsman button. This means that alternatives to the “best choice” are shown only when needed and requested. This is less distracting to the user and allows an uninterrupted task flow.

The ombudsman is a service that is application dependent. This means that various applications can register to the ombudsman, and—by the registration —get application specific services from the ombudsman. In the present solution, all the settings of an application can be made in one go. In the case of events that are not understood by the user, the ombudsman (upon request) lists possible causes and suggests what parameters can be changed.

The ombudsman can be implemented in various ways, but one example is disclosed in the following.

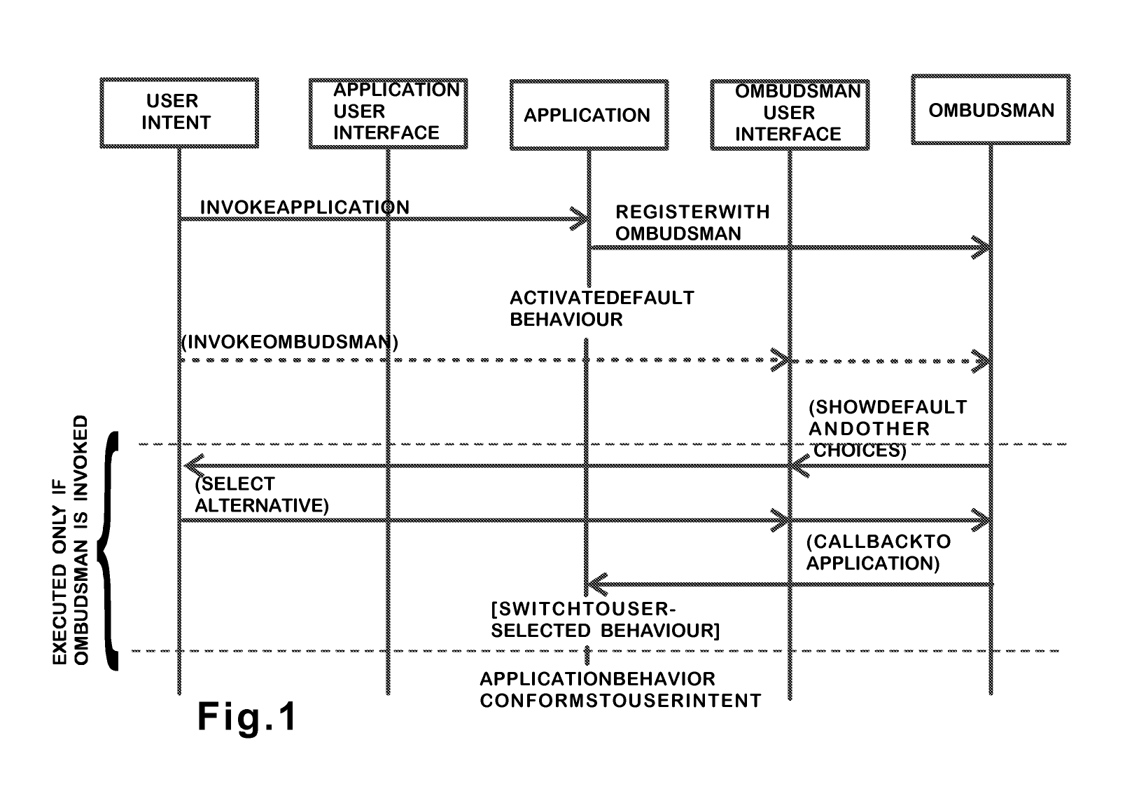

The ombudsman is implemented as a software server or a daemon. An example of the operation of the ombudsman is illustrated in FIG. 1. Applications that need to make policy decisions can register with the ombudsman service. At the time of registration, the applications indicate the identity of the application; the menu of choices that should be shown to the user in case of ombudsman is invoked; and the time period during which this menu should remain active. In addition, the applications may indicate a callback function that defines the order in which the functions are executed when called by the ombudsman. Optionally, possible sources of context information can be shown to the user to help the user to make an informed choice. This enables easy integration with other applications and consistent user experience. The time period during which menu of choices is active can be short (e.g. 10 s of seconds).

The application may also indicate if there should be a notification shown to the user indicating that the application has made a default choice but the user can change it by invoking the ombudsman. After registration, the ombudsman service activates default behaviour (i.e. default policy) in the registered application. This makes the application to be executed with the default behaviour as long as the default behaviour is suitable for the execution. The default policies for the application are either selected by the user or inferred from the user's behaviour. The user's behaviour can be utilized e.g. by studying the behaviour in the past. This can have different degrees of granularity, i.e. accept offers from a certain service providers, but reject others. In another example, user's physical context can be defined. For example, if it is determined that the user is in hurry (deduced from the user running), no advertisements are shown. However, if the user is walking at low pace, the advertisements are presented.

When the default policy does not provide an appropriate action, the user can invoke the ombudsman either by clicking a notification (if the notification indicating on the default policy is shown) or by explicit invocation e.g. by pressing a special ombudsman button. The latter option can be realized to be more user-friendly.

The notification can be implemented in various ways. A notification can be given to indicate that the user can change the default policy by pressing the ombudsman. Once pressed the alternative policies are shown. The visual representation of the notification can be the same for all applications (the user may change the current default value), or context specific (for example the user can change the current default value of headphones to TV-out).

The special ombudsman button may be an icon (i.e. a UI element) or a physical button. The physical button may be used without visible icons to the user. By this, the user is trained to select the ombudsman function with the ombudsman button. The physical button may also be used with visible icons to the user, whereby the user is allowed to see the alternative policies and to press the ombudsman button. If the ombudsman is only an icon on a screen (no physical buttons involved), the user can select the icon with the cursor.

The implementation of the ombudsman can also be a combination of the physical button and the icon.

In any case, the invocation (performed by the user) of the ombudsman makes the ombudsman to show the default and the other possible policies to the user. By this, the user may select an alternative policy instead of the default. After the selection, the ombudsman activates the selected policy in the application so that the application is controlled to operate according to that policy.

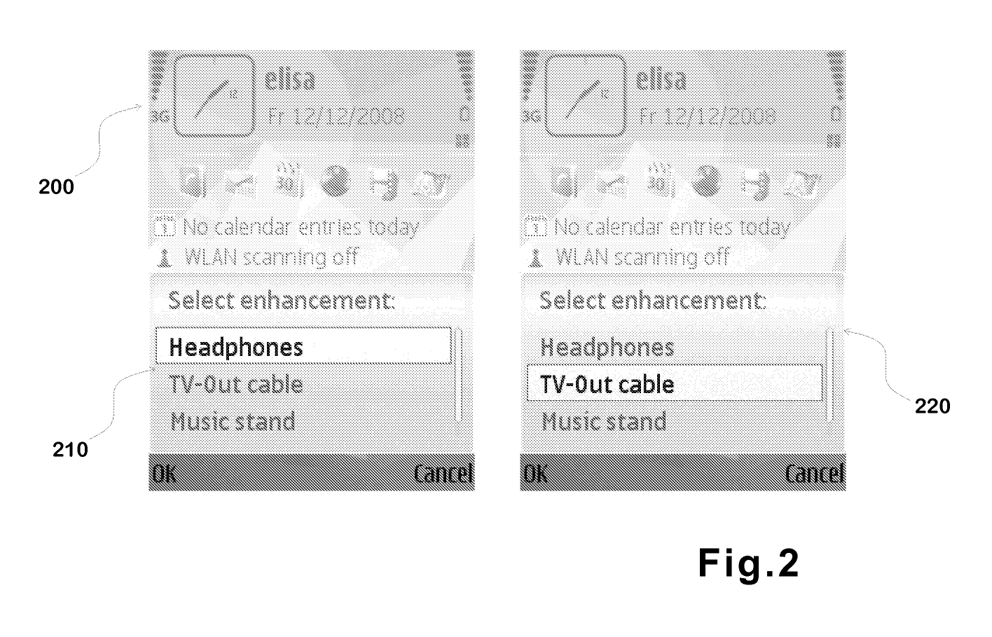

FIG. 2 illustrates an example of display view 200 and represents the first use case. In mobile devices, a slot for headphones is also used for TV-out or music stand. However, most likely, the slot is frequently used by headphones. In this example the default policy is thus headphones usage (as shown in menu 210). If the user takes another device, s/he can—with a simple click—select an alternative policy instead of headphones, e.g. TV-Out cable (as shown in menu 220). In other words, the operation of ombudsman starts by default using headphones every time the slot is used. However, if something else is desired, the user may press the ombudsman button and to select TV-Out cable from the selection list provided by the ombudsman.

This kind of operation is advantageous, because when it is directly determined that the user uses the headphones, the application can immediately start with e.g. displaying a list of songs from which the user can choose one to play. This makes the usage of the headphones more straightforward and less disturbing because of fewer selections.

For some situations the ombudsman does not expect user-initiated request, but is capable of operating automatically. For example, if the user desires to use the TV-out but forgets to change the enhancement mode, the TV will not show the images. This can be seen as an incorrect behaviour of the system from the user perspective. The ombudsman is able to determine that the selected mode does not match the connected peripheral (e.g. as a result of an active measurement by the ombudsman), and based on that the ombudsman can select the appropriate mode, or present the user with the alternative policies. In addition to the list of default policies and menu items, the ombudsman also requires a list of expected parameter values (e.g. impedance, USB signal, etc) from the possible peripheral devices. When the ombudsman notices that an inappropriate action has occurred (e.g. there is nothing shown on television), the ombudsman can change the enhancement by itself and without making any confirmation queries from the user. Of course, this does not restrict the user from invoking the ombudsman button so that s/he can make the policy decision, even though the ombudsman service is capable of making the decision.

Another example relates to safe (secure) defaults. For privacy reason, the safest default is “not to share”. If a user wants to share more, s/he can define a white list being provided for a particular privilege but this should be static. Implementation of the ombudsman allows temporarily people more privileges for a specific action.

In one example, a certain newspaper has a privilege to obtain city-wide location information. The service the newspaper offers, for example a discount for a local store and which the user wants to use, requires detailed location information on the user. The user has defined her/his default location with accuracy of 10 km. If the user does not change the setting, the user will not receive the discount.

When the user notices that s/he does not receive the discount, because of too inaccurate location, is this, from her/his perspective, incorrect behaviour. In the present solution, the user may invoke the ombudsman that will show the menu choices: private—city-wide (default)—neighbourhood—exact. The user may infer that the privacy settings are incorrect, and decide to change the setting for that moment. If the request from the user is not received, the application would have continued running with the default setting.

Because of the present solution, the number of redundant user prompts before and during application usage can be reduced. The present solution is also configured to assist the user to find errors due to misalignment of user expectation, e.g. when user is expecting to see something on television, but sees nothing.

Thanks to the present solution, the settings (also privacy settings) can be easily changed to temporarily changed application parameters. In addition, the device can be used more efficiently because of less pop-ups appear in the display. Yet further, the solution habituates for exceptions so that unexpected events are reacted but when nothing unexpected occurs, then nothing is done.

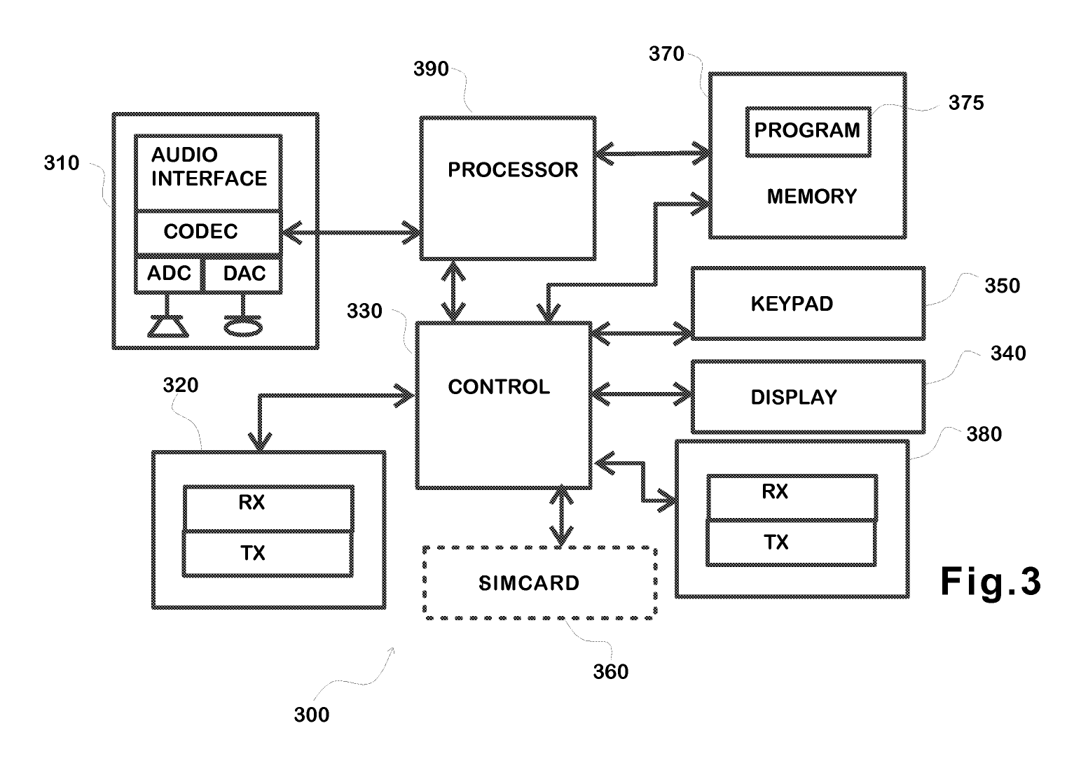

An example of an electronic apparatus utilizing an ombudsman service is illustrated in FIG. 3. The apparatus 300 comprises a processor 390 (Digital Signal Processor, DSP) for processing data and a memory 370 that may store applications and various data etc. The apparatus also comprises computer program code 375 residing in the memory 370. The memory 370 may be, but is not limited to, a single memory, CD, DVD, ROM, RAM, EEPROM, optical storage, or any other non-volatile storage medium capable of storing digital data.

The apparatus 300 comprises also a control unit 330 for controlling functions in the apparatus 300. The control unit 330 (MCU, Main Control Unit) may comprise one or more processors. The control unit 330 may run a user interface software to facilitate user control of at least some functions of the apparatus 300. The control unit 330 may also deliver a display command and a switch command to a display 340 to display visual information, e.g. a user interface. The apparatus may also comprise a keypad 350 for receiving input from the user. The control unit 330 may also communicate with the processor 390 and can access an optionally incorporated SIM card 360 and a memory 370. An optionally incorporated SIM card 360 is configured to carry, for instance, important information, such as a cellular phone number, subscription details, and security information for the apparatus. The SIM card 360 serves primarily to identify the apparatus on a radio network. The card 360 also contains a memory for storing a personal telephone number registry, text messages, and user specific settings.

Yet further, the apparatus may comprise various communication means 320, 380 having a transmitter and a receiver for connecting to the network and for sending and receiving information. The first communicating means 320 can be adapted for telecommunication and the other communicating means 380 can be a one kind of short-range communicating means, such as Bluetooth™ system, WLAN system (Wireless Local Area Network) or other system which suits for local use and for communicating with another device, for example DVB USB (Digital Video Broadcasting Universal Serial Bus), TV connector.

The apparatus 300 can also comprise other means, such as audio means 310, including an earphone and a microphone and optionally a codec for coding (and decoding, if needed) the audio information. Further the apparatus 300 can operate also with location/positioning systems, e.g. a GPS (Global Positioning System). The apparatus 300 can have other functionalities (e.g. imaging means) or can be connected to other computerized systems for enhancing the operation of the apparatus.

In the previous, a service by means of which user prompts can be minimized has been disclosed. Even though the ombudsman service was described by means of an example relating to mobile devices, it is appreciated the service may be implemented in many ways and in various electronic devices.

1.-20. (canceled)

21. A method comprising
electronically controlling an application to be executed with default policies throughout application tasks;
noticing when a default policy is an inappropriate action for an application task being encountered in said application; and
activating another policy from a list of default and alternative policies to said application.

22. The method according to claim 21, wherein in order to notice that a default policy results in inappropriate action the method comprises receiving a user-initiated request to display other policies, wherein as a response to the request, a list comprising default and alternative policies for the encountered situation is displayed on the user interface, the method further comprising receiving a user selection for one of the policies in the list, activating said one of the policies and initiating the application to operate with the activated policy.

23. The method according to claim 21, wherein the step of noticing that a default policy is an inappropriate action comprises automatically selecting one of the policies among default and alternative policies that is suitable for the encountered situation, activating the selected policy and controlling the application to operate with the activated policy.

24. The method according to claim 21, wherein the encountered situation relates to an erroneous application setting or to a need to change application setting policies.

25. The method according to claim 21, wherein the default policy has been selected by the user or is inferred from user's behaviour.

26. The method according to claim 21, comprising receiving the list of default and alternative policies via registration request from said application, the registration request further comprising indicating at least one of the following: an identity of the application, a menu of choices to be displayed on the user interface and relating to the policies, a time period during which the menu of choices is active, help information to the user to make the right choice, a callback function, a notification shown to the user on the default policy.

27. The method according to claim 22, wherein the user-initiated request is received via a notification or by an explicit invocation on the user interface.

28. An apparatus comprising a processor and a memory storing executable instructions that, in response to execution by the processor, cause the apparatus to at least:
control an application to be executed with default policies throughout the application tasks;
notice when a default policy is an inappropriate action for an application task being encountered in said application; and to
activate another policy from a list of default and alternative policies to said application.

29. The apparatus according to claim 28, further comprising computer program code configured to cause the apparatus, in order to notice that the default policy results in inappropriate action, to receive a user-initiated request to display other policies, wherein as a response to the request, the apparatus is configured to display a list comprising default and alternative policies for the encountered situation on the user interface, wherein the apparatus is further configured to receive a user selection for one of the policies in the list, to activate said one of the policies and to control the application to operate with the activated policy.

30. The apparatus according to claim 28, further comprising computer program code configured to cause the apparatus to notice automatically that the default policy is inappropriate action, to select automatically one of the policies among default and alternative policies that is suitable for the encountered situation, to activate the selected policy and to control the application to operate with the activated policy.

31. The apparatus according to claim 28, wherein the encountered situation relates to an erroneous application setting or to a need to change application setting policies.

32. The apparatus according to claim 28, wherein the default policy has been selected by the user or the apparatus is configured to infer the default policy from user's behaviour.

33. The apparatus according to claim 28, further comprising computer program code configured to cause the apparatus to receive the list of default and alternative policies via registration request from said application further indicating at least one of the following: an identity of the application, a menu of choices to be displayed on the user interface and relating to the policies, a time period during which the menu of choices is active, help information to the user to make the right choice, a callback function, a notification shown to the user on the default policy.

34. The apparatus according to claim 29, further comprising computer program code configured to cause the apparatus to receive the user-initiated request via a notification or by an explicit invocation on the user interface.

35. An apparatus according to claim 28, being a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

36. A computer program product stored on a non-transitional computer readable medium, comprising executable instructions that, in response to execution by a processor, are adapted to perform
controlling an application to be executed with default policies throughout the application tasks;
noticing when a default policy is an inappropriate action for an application task being encountered in said application;
activating another policy from a list of default and alternative policies to said application.

37. The computer program product according to claim 36, wherein, in order to notice that a default policy results in inappropriate action, the computer program product further comprises instructions to perform receiving a user-initiated request to display other policies for the application task, wherein as a response to the request, a list comprising default and alternative policies for the encountered situation is displayed on the user interface, and receiving a user selection for one of the policies in the list, activating said one of the policies, and controlling the application to operate with the activated policy.

38. The computer program product according to claim 36, further comprising instructions to automatically notice that a default policy is an inappropriate action, to automatically select one of the policies among default and alternative policies that is suitable for the encountered situation, to activate the selected policy and to control the application to operate with the activated policy.

39. The computer program product according to claim 36, wherein the encountered situation relates to an erroneous application setting or to a need to change application setting policies.

40. The computer program product according to claim 36, wherein the default policy has been selected by the user or is inferred from user's behaviour.
